(19) United States
(12) Patent Application Publication
(10) Pub. No.: US 2024/0054220 A1
(43) Pub. Date: Feb. 15, 2024

(54) SYSTEM AND METHOD FOR GAMING WORKFLOW BETWEEN ENTITIES WITHIN A GAMING ENVIRONMENT

(71) Applicant: Merydyan Technologies LLC, Appleton, WI (US)

(72) Inventor: Dennis Michael Sheldon, Jr., Shawano, WI (US)

(21) Appl. No.: 18/232,249

(22) Filed: Aug. 9, 2023

Related U.S. Application Data
(60) Provisional application No. 63/396,525, filed on Aug. 9, 2022.

(51) Int. Cl. G06F 21/57; G06F 21/12

(52) U.S. Cl. CPC G06F 21/57; G06F 21/121

(57) ABSTRACT

A system and method for gaming workflow between entities within a gaming environment includes a database configured to store data from a Test Lab, a computing system configured to communicate with the database, and an application executable by a processor of a computing device and to communicate with the computing system, wherein the application is configured to have the processor programmed with an algorithm execute instructions to enable a user to access the database, access the computing system by a Supplier to ensure required software has been approved, view the data and make a request to a Regulator to carry out final installation of the approved software on gaming machines in a Gaming Operation, maintain records of the software and gaming machines through end of life, and send notification to the Gaming Operation and the Regulator if a piece of the approved software is revoked by the Test Lab.

### CROSS-REFERENCE TO RELATED APPLICATION(S)

The present application claims the benefit of and priority to U.S. Provisional patent application Ser. No. 63/396,525, filed Aug. 9, 2022, the entire disclosure of which is hereby expressly incorporated by reference.

### BACKGROUND OF THE INVENTION

### Field of the Invention

The present disclosure relates generally to a gaming environment and, more specifically, to a system and method for gaming workflow between entities within a gaming environment.

### Description of Related Art

It is known that a Gaming Operation such as a casino has one or more gaming machines to allow patrons to play games. The Gaming Industry is heavily regulated, and control of the software used in gaming machines must be closely monitored and controlled. For example, faulty software left on a gaming machine may expose the Gaming Operation to potential fraud and excessive fines.

Communication typically occurring between four primary entities engaged in the Gaming Industry has always been a challenge, specifically as it relates to sharing relevant data in a timely manner. For example, the Gaming Operation, Regulator, Supplier, and Test Lab entities need to share information.

In traditional systems and processes, these four gaming entities do not have access to the same information all at the same time, leading to delays in software revocations, approvals, and shipments.

Certification Database Interface (CDI) protocol was developed as a common interface for sharing data, mainly from Test Labs to any interested party or entity.

Most solutions for the Gaming Industry today focus on one of the four entities mentioned above, and none adequately address the need of all four entities to have access to the same data or information in near real-time.

The present disclosure is aimed at solving one or more of these needs identified above.

### SUMMARY OF THE INVENTION

The present invention provides a system for gaming workflow between entities within a gaming environment including a database configured to store data from a Test Lab, a computing system configured to communicate with the database, and an application executable by a processor of a computing device and the computing device to communicate with the computing system. The application is configured to have the processor programmed with an algorithm to execute instructions to enable a user to access the database, access the computing system by a Supplier to ensure required software has been approved, view the data and make a request to a Regulator to carry out final installation of the approved software on gaming machines in a Gaming Operation, and send notification to the Gaming Operation and the Regulator if a piece of the approved software is revoked by the Test Lab.

The present invention also provides a method for gaming workflow between entities within a gaming environment including the steps of storing, in a database, data associated with a Test Lab, enabling, by a computing system, a computing device of a user to access the database, executing an application by a processor of a computing device to communicate with the computing system, wherein the application is configured to have the processor programmed with an algorithm to execute instructions accessing, by a Supplier, the computing system to ensure the required software has been approved, viewing, by a Gaming Operation, the data and making a request to a Regulator to carry out final installation of the approved software on gaming machines in the Gaming Operation, and sending, by the computing system, notices to the Gaming Operation and the Regulator if a piece of the approved software is revoked by the Test Lab.

One advantage of the present invention is that a system and method is provided for gaming workflow between entities within a gaming environment. Another advantage of the present invention is that the system and method utilize CDI protocol to extract tested software results from the Test Labs and share data or information that with a Gaming Operation, Regulator, and Supplier. Yet another advantage of the present invention is that the system and method allows the Regulator to use this data or information to make more timely decisions on software updates and installs on a floor of the Gaming Operation where they have oversight. Still another advantage of the present invention is that the system and method will make the necessary Test Lab data available to the Gaming Operation, Regulator, and Supplier to support a streamlined mechanism to ensure only properly validated software is allowed within the Gaming Operation. A further advantage of the present invention is that the system and method address those issues and ensures that the Gaming Operation, Regulator, Supplier and Test Lab all have the ability to share information within a common framework.

Other advantages and features of the present disclosure will be readily appreciated, as the same becomes better understood, by reference to the subsequent detailed description, when considered in connection with the accompanying drawings.

### BRIEF DESCRIPTION OF THE DRAWINGS

Non-limiting and non-exhaustive embodiments of the present invention are described with reference to the following figures, wherein like numerals refer to like parts throughout the various views unless otherwise specified.

FIG. 1 is a block diagram illustrating an exemplary system for gaming workflow between entities within a gaming environment, according to one embodiment of the present invention.

FIG. 2 is a block diagram of a computing device that may be used with the system shown in FIG. 1.

FIG. 3 is a flow diagram of a gaming workflow that may be used with the system shown in FIG. 1.

FIG. 4 is a block diagram of a method for gaming workflow between entities within a gaming environment that may be used with the system shown in FIG. 1.

### DETAILED DESCRIPTION OF THE PREFERRED EMBODIMENT(S)

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an examples” means that a particular feature, structure or characteristic described in connection with the embodiment of example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system”. Furthermore, the present invention may take the form of a computer program product embodied in any tangible media or expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisional via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The block diagram(s), flow diagram(s), and flowchart(s) illustrate the architecture, functionality, and operation of possible implementations of systems, methods, and computer program products according to various embodiments of the present invention. In this regard, each block in the flowchart, flow diagrams, or block diagrams may represent a module, segment, or portion of code, which comprises one or more executable instructions for implementing the specified logical function(s). It will also be noted that each block of the block diagrams, flow diagrams, and/or flowchart illustrations, and combinations of blocks in the block diagrams, flow diagrams, and/or flowchart illustrations, may be implemented by special purpose hardware-based systems that perform the specified functions or acts, or combinations of special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart, flow diagram, and/or block diagram block or blocks.

Several (or different) elements discussed below, and/or claimed, are described as being “coupled”, “in communication with” or “configured to be in communication with”. This terminology is intended to be non-limiting, and where appropriate, be interpreted to include without limitation, wired and wireless communication using any one or a plurality of suitable protocols, as well as communication methods that are constantly maintained, are made on a periodic basis, and/or made or initiated on an as needed basis.

The present disclosure particularly describes a system and method for gaming workflow between entities with a gaming environment to ensure that the entities such as a Gaming Operation, Regulator, Supplier, and Test Lab all have the ability to share information within a common framework. The present disclosure provides a system and method for gaming workflow that utilizes CDI protocol to extract tested software results from one or more Test Lab(s) and share those results with one or more Gaming Operation(s), Regulator(s), and Supplier(s). In the present disclosure, the Regulator uses this information to make more timely decisions on software updates and installs on the floor of the Gaming Operation where they have oversight. In the present disclosure, the Gaming Operation will rely on the Test Lab data to quickly identify any software that has been revoked or replaced to promptly remove any affected gaming machines from the Gaming Operation, ensuring real-time compliance. In the present disclosure, the Supplier will utilize the information to speed up the process of shipping new gaming machines and receiving approvals from one or more Regulator(s) to do so. In addition, the Supplier will also leverage these workflows to quickly and efficiently license their employees with one or more Gaming Operation(s). It should be appreciated that this is a heavily resource intensive process with traditional systems and workflows.

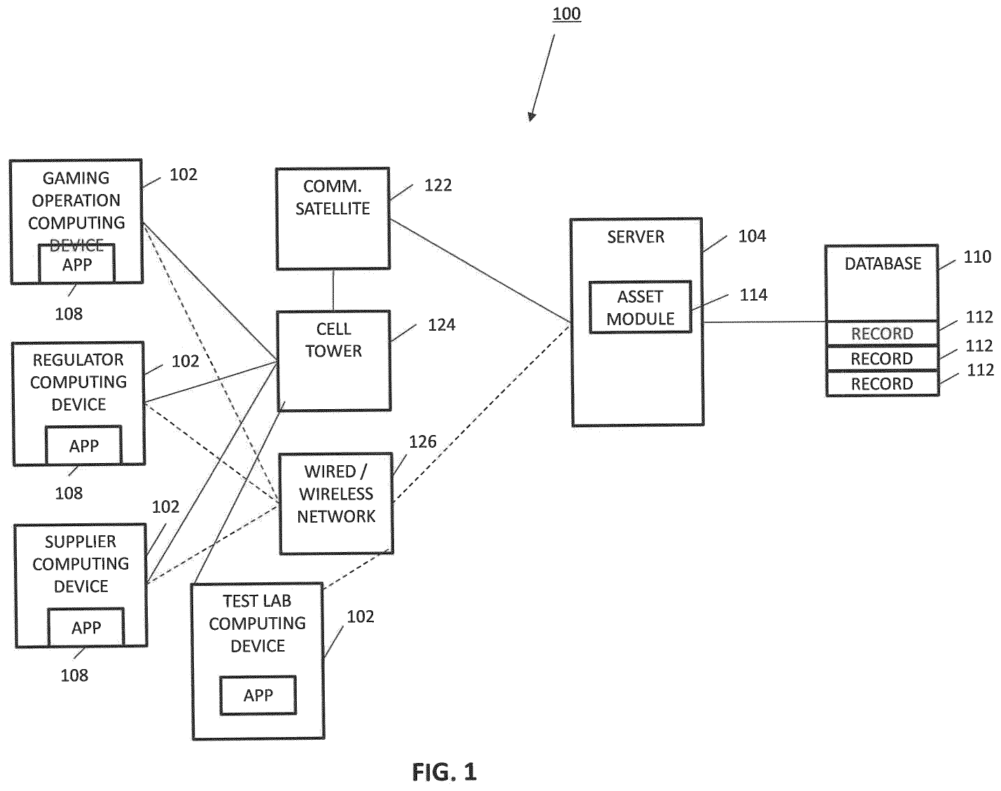

FIG. 1 is a block diagram of an exemplary system 100 that may be used for gaming workflow to share information between entities within a gaming environment. To implement this workflow, the system 100 is implemented for one or more Gaming Operation(s) or Regulator(s). In one embodiment, the system 100 includes one or more computing devices such as a Gaming Operation computing device 102, a Regulator computing device 102, a Supplier computing device 102, and a Test Lab computing device 102. The system also includes a server 104 connected or in communication with the Gaming Operation computing device 102, the Regulator computing device 102, the Supplier computing device 102, and the Test Lab computing device 102. The various components of the system 100 may be connected together by one or more wired or wireless networks. Although four computing devices 102 are illustrated in FIG. 1, the system 100 may include any suitable number of the computing devices 102. Also, while the system 100 is illustrated with the above components, it should be appreciated that one or more components of the system 100 may be combined together or split apart while remaining within the scope of the disclosure.

The computing device 102 is a computing device that may be operated by a user (sometimes referred to herein as a Gaming Operation, Regulator, Supplier, and Test Lab) to communicate with each other. The computing devices 102 may include a mobile phone, a personal digital assistant (PDA), a tablet computer, a wearable computing device, a laptop computer, a desktop computer, a kiosk, a point-of-sale terminal, a virtual reality device, an augmented reality device, or any other suitable computing device that enables the computing device 102 to operate as described herein. In one embodiment, an application or “app” 108 is installed on each computing device 102 to enable communication with each other.

The server 104 is a computing device that enables multiple computing devices 102 to access and transmit data. In one embodiment, the server 104 stores information or data from the Test Lab in a database 110 that each user may access and receive the information or data from the server 104. The information may be stored in a plurality of records 112 in the database 110. The records 112 may include information or data about software and/or gaming machines. The server 104 may retrieve the records 112 from the database 110 by querying the database 110 during operation.

In one embodiment, the server 104 includes an Asset module 114 that can retrieve a list of all Approved, Denied, and Revoked software for a particular jurisdiction from the database 110. For example, the Asset module 114 may track a listing of all Approved, Denied, and Revoked software for a particular jurisdiction, and/or any other suitable statistic.

In one embodiment, the system 100 includes devices that enable the computing devices 102 to transmit and receive data to and from the server 104. The devices may include one or more communication satellites 122, one or more cellular towers 124, and devices forming one or more wired or wireless networks 126. In one embodiment in which the computing devices 102 are cellular phones, the computing devices 102 may communicate with the server 104 by transmitting signals to the cellular tower 124 which then transmits the signals to the communication satellite 122. The communication satellite 122 transmits the signals to the server 104. In turn, the server 104 may transmit signals to the computing devices 102 in the reverse direction via the communication satellite 122 and the cellular tower 124. It should be appreciated that the computing devices 102 may communicate with the server 104 via one or more wired or wireless of the networks 126, such as the Internet.

In one embodiment, the signals transmitted between the computing devices 102 and the server 104 are encrypted using a suitable encryption algorithm. For example, the signals may be encrypted using a public key infrastructure (PKI) algorithm. In another embodiment, the signals may be encrypted using any suitable algorithm.

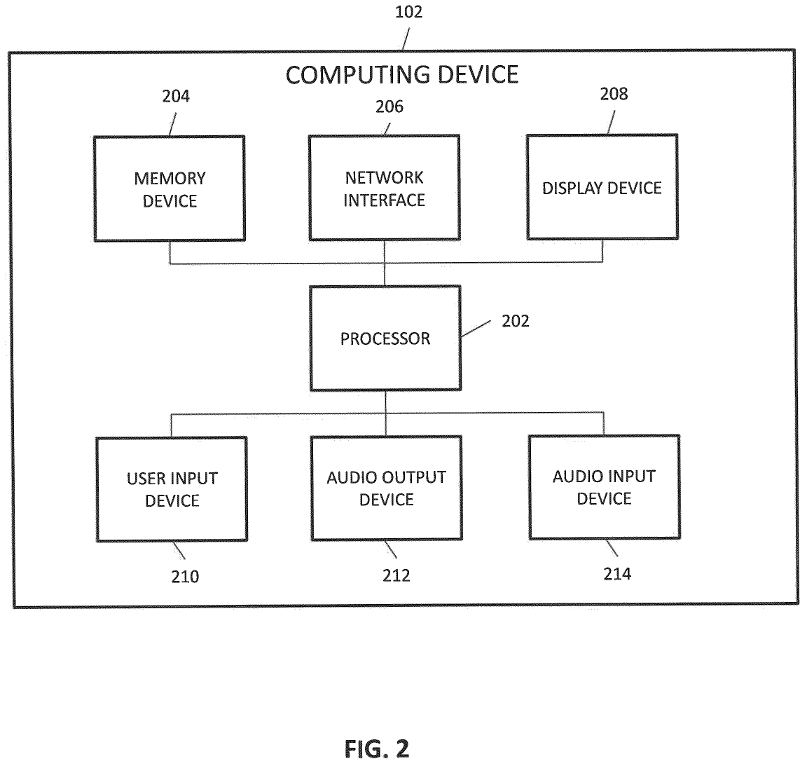

FIG. 2 is a block diagram of one embodiment of the computing device 102 that may be used with the system 100 (shown in FIG. 1). In one embodiment, the computing device 102 and server 104 described in the system 100 may be implemented as the computing device 102. However, it should be recognized that one or more components of the system 100 may not be included in the computing device 102 such as the server 104.

In one embodiment, the computing device 102 includes a processor 202, a computer-readable memory device 204, and a network interface 206. In one embodiment, the computing device 102 may also include a display device 208, an input device 210, an audio output device 212, and/or an audio input device 214. It should be appreciated that the memory device 204, network interface 206, display device 208, and input device 210 (if provided) may be connected to the processor 202 and/or to each other via any suitable bus or busses, interfaces, or other mechanisms.

The processor 202 includes any suitable programmable circuit including one or more microcontrollers, microprocessors, application specific integrated circuits (ASICs), systems on a chip (SoCs), programmable logic circuits (PLCs), field programmable gate arrays (FPGAs), and/or any other circuit capable of executing the functions described herein. The above examples are exemplary only, and thus are not intended to limit in any way the definition and/or meaning of the term “processor.”

The memory device 204 is an electronic storage device that includes one or more non-transitory computer readable medium, such as, without limitation, random access memory (RAM), flash memory, a hard disk drive, a solid-state drive, a compact disc, a digital video disc, and/or any suitable memory. The memory device 204 may include data as well as instructions that are executable by the processor 202 to program the processor 202 to perform the functions described herein. For example, the methods described herein may be performed by one or more processors 202 executing instructions stored within one or more of the memory devices 204.

The network interface 206 may include, without limitation, a network interface controller (NIC) or adapter, a radio frequency (RF) transceiver, a public switched telephone network (PSTN) interface controller, or any other communication device that enables the computing devices 102 to operate as described herein. In one embodiment, the network interface 206 may connect to the network interfaces 206 of the other user computing devices 102 of the system 100 through a network using any suitable wireless or wired communication protocol.

The display device 208 may include, without limitation, a liquid crystal display (LCD), a vacuum fluorescent display (VFD), a cathode ray tube (CRT), a plasma display, a light-emitting diode (LED) display, a projection display, a display integrated into a virtual reality or augmented reality device, and/or any suitable visual output device capable of displaying graphical data and text to a user. For example, the display device 208 may be used to display a graphical user interface associated with the application 108 to the user.

The input device 210 may include, without limitation, a keyboard, a keypad, a touch screen, a mouse, a scroll wheel, a pointing device, a video input device that registers movement of a user (e.g., usable with an augmented reality input device or a virtual reality input device), and/or any other suitable device that enables the user to input data into the computing device 102 and/or retrieve data from the computing device 102.

The audio output device 212 may include, without limitation, one or more speakers or any other device that enables content to be audibly output from the computing device 102. For example, music or other audio content may be audibly output from the audio output device 212.

The audio input device 214 may include a microphone or another suitable device that enables the user to input audio commands into the computing device 102. The audio input device 214 may employ speech recognition software to convert spoken commands from the user into digital data for use in operating the computing device 102.

While the foregoing components have been described as being included within the computing devices 102, it should be appreciated that at least some of the computing devices 102 may not include each component. For example, a server may not include the audio output device 212, audio input device 214, input device 210, and/or display device 208. In addition, the computing device 102 may include any suitable number of each individual computing device component. For example, the computing device 102 may include a plurality of the processors 202 or processor cores, a plurality of the memory devices 204 (of the same or different types, sizes, etc.), and/or a plurality of the display devices 208.

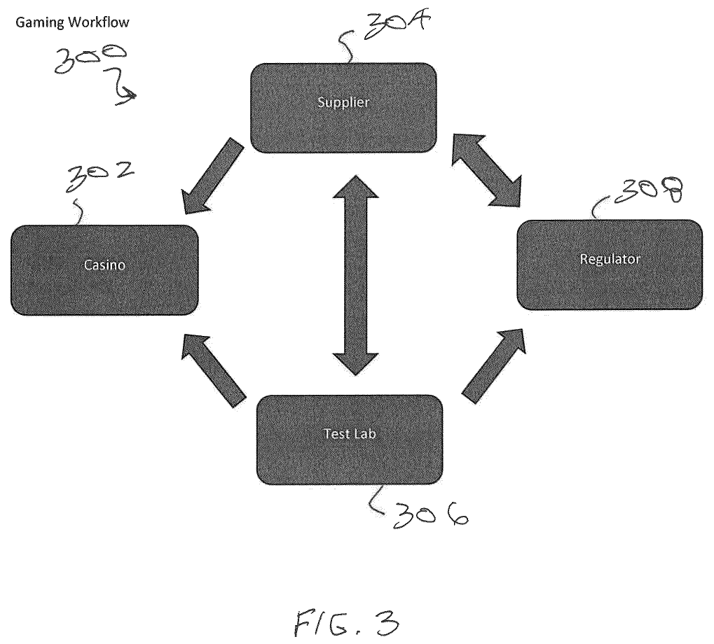

FIG. 3 is a flow diagram of a gaming workflow 300 between entities within a gaming environment that may be used with the system 100 shown in FIG. 1. In FIG. 3, the gaming workflow 300 includes a plurality of entities including a Gaming Operation 302 such as a casino, a Supplier 304 who supplies gaming machines to the Gaming Operation 302, and a Test Lab 306 that supplies software for the gaming machines to the Gaming Operation 302. The gaming workflow 300 also includes communication between the Supplier 304 and the Test Lab 306. The gaming workflow 300 further includes a Regulator 308 that receives the software from the Test Lab 306 and communication with the Supplier 304. It should be appreciated that one or more Gaming Operation(s) 302, Supplier(s) 304, Test Lab(s) 306, and Regulator(s) 308 may be included for the gaming workflow 300.

Using CDI, the data from the Test Lab 306 is pulled into the system 100 and made available through a user interface of the application 108 to end users or entities previously described. The Regulator 308 has access to the data from the Test Lab 306 through the Assets module 114 of the server 104, where there is information such as a listing of all Approved, Denied, and Revoked software for a particular jurisdiction, allowing the Regulators 308 to make informed decisions on requests made by Suppliers 304 and the Gaming Operations 302.

Suppliers 304 that need to ship software and gaming machines to the Gaming Operation 302 have access to the system 100 to ensure the required software has been approved by the Regulator 308 and may be shipped to the Gaming Operation 302. It should be appreciated that access by the Supplier 304 is provided to initiate the shipment, indicating the tested software to be provided, and to follow the request through to approval.

Once the shipped software and gaming machines have been delivered to the Gaming Operation 302, the Gaming Operation 302 will view the data or information and make a request within the system 100 to carry out the final installation. Going forward, the Gaming Operation 302 will maintain a record of the software and gaming machines through their end of life. If a piece of software is revoked by the Test Labs 306, the Gaming Operation 302 and Regulator 308 will receive automated notices of the action, allowing them to take immediate action.

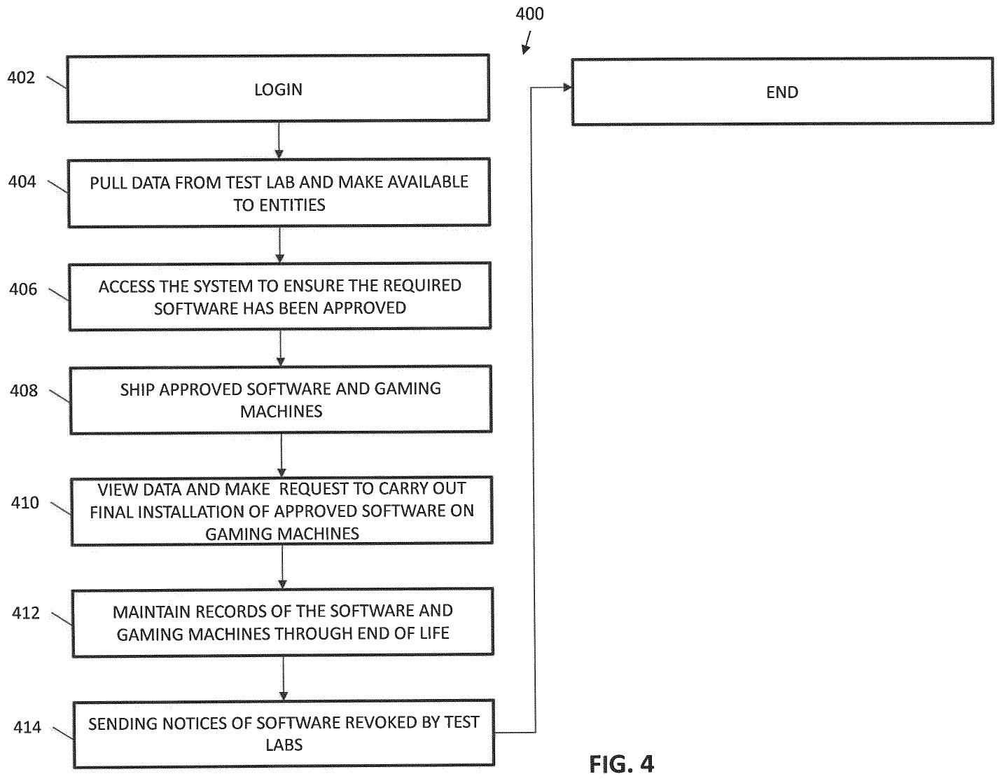

FIG. 4 is a flow diagram of an exemplary method 400 of the gaming workflow 300 that may be used with the system 100 (shown in FIG. 1). The method 400 may be implemented by the computing device 102 and/or server 104 (shown in FIG. 1), such as by the processor 202 of the computing device 102 and/or server 104 executing computer-readable instructions stored within the memory device 204 of the computing device 102 and/or server 104. In another embodiment, the method 400 may be implemented by any suitable device of the system 100.

In one embodiment, the method 400 is programmed as an algorithm to include the step 402 of logging in by a user of the computing device 102. The method 400 includes the step 404 of pulling or inputting data or information from the Test Lab 306 into the system 100 and making the data or information available through the user interface to the entities within the gaming environment. The method 400 includes the step 406 of accessing the system 100 to ensure the required software has been approved. For example, suppliers 304 that need to ship software and gaming machines to the Gaming Operation 302 have access to the system 100 to ensure the required software has been approved by the Regulator 308 and may be shipped to the Gaming Operation 302. It should be appreciated that access to the data or information is provided to initiate the shipment, indicating the tested software to be provided, and to follow the request through to approval. It should also be appreciated that the Regulator 308 has access to the data or information from the Test Lab 306 through the Assets module 114 of the server 104, where there is a listing of all Approved, Denied, and Revoked software for a particular jurisdiction, allowing them to make informed decisions on requests made by Suppliers 304 and the Gaming Operation 302.

The method 400 includes the step 408 of shipping the approved software and gaming machines. For example, the Supplier 304 ships the approved software and gaming machines to the Gaming Operation 302. The method 400 also includes the step 410 of viewing the data or information and making a request to carry out final installation of the approved software on the gaming machines. For example, once the shipped software and gaming machines have been delivered to the Gaming Operation 302, the Gaming Operation 302 will view the data and make a request within the system 100 to carry out the final installation.

The method 400 includes the step 412 of maintaining records of software and gaming machines. For example, the Gaming Operation 302 will maintain a record of the software and gaming machines through their end of life. The method 400 includes the step 414 of sending notices of software revoked by the Test Labs. For example, if a piece of approved software is revoked by the Test Labs 306, the Gaming Operation 302 and Regulator 308 will receive automated notices of the action, allowing them to take immediate action including removing the software from the gaming machines.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for gaming workflow between entities in a gaming environment comprising:
a database configured to store data from a Test Lab;
a computing system configured to communicate with the database; and,
an application executable by a processor of a computing device and the computing device to communicate with the computing system, wherein the application is configured to have the processor programmed with an algorithm to execute instructions to:
enable a user to access the database;
access the computing system by a Supplier to ensure required software has been approved;
view the data and make a request to a Regulator to carry out final installation of the approved software on gaming machines in a Gaming Operation; and
send notification to the Gaming Operation and the Regulator if a piece of the approved software is revoked by the Test Lab.

2. A system as set forth in claim 1 wherein the user logs into the computing system with the computing device.

3. A system as set forth in claim 1 wherein the data or information is inputted or pulled from the Test Lab into the computing system.

4. A system as set forth in claim 1 wherein the Supplier ships the approved software and gaming machines to the Gaming Operation.

3. A system as set forth in claim 1 wherein the send notification comprises sending notices of software revoked by the Test Labs.

5. A system as set forth in claim 1 wherein the data is made available through the application to the user.

6. A system as set forth in claim 1 wherein the Supplier has access to the data to initiate a shipment, indicate tested software to be provided, and to follow the request through to approval.

8. A system as set forth in claim 1 wherein the Gaming Operation maintains records of the software and gaming machines through end of life.

9. A system as set forth in claim 1 wherein the notices are received by the Gaming Operation and the Regulator to allow the Gaming Operation and the Regulator to take immediate action.

10. A system as set forth in claim 9 wherein the immediate action comprises removing the revoked piece of approved software is removed from the gaming machines.

11. A method for gaming workflow between entities in a gaming environment comprising the steps of:
storing, in a database, data associated with a Test Lab;
enabling, by a computing system, a computing device of a user to access the database;
executing an application by a processor of the computing device to communicate with the computing system, wherein the application is configured to have the processor programmed with an algorithm to execute instructions:
accessing, by a Supplier, the system to ensure required software has been approved;
viewing, by a Gaming Operation, the data and making a request to a Regulator to carry out final installation of the approved software on gaming machines in the Gaming Operation; and
sending, by the computing system, notices to the Gaming Operation and the Regulator if a piece of the approved software is revoked by the Test Lab.

12. A method as set forth in claim 11 including the step of logging into the computing system by the user of the computing device.

13. A method as set forth in claim 11 including inputting or pulling the data from the Test Lab into the computing system.

14. A method as set forth in claim 11 wherein the step of sending comprises sending notices of software revoked by the Test Lab.

15. A method as set forth in claim 11 including the step of making the data available through the application to the user.

16. A method as set forth in claim 11 including the step of accessing, by the Supplier, the data to initiate a shipment, indicate tested software to be provided, and to follow the request through to approval.

17. A method as set forth in claim 11 including the step of shipping, by the Supplier, the approved software and gaming machines to the Gaming Operation.

18. A method as set forth in claim 11 including the step of maintaining, by the Gaming Operation, of the software and gaming machines through end of life.

19. A method as set forth in claim 12 including the step of receiving the notices by the Gaming Operation and the Regulator and allowing the Gaming Operation and the Regulator to take immediate action.

20. A method as set forth in claim 19 wherein the immediate action comprises removing the revoked piece of approved software is removed from the gaming machines.
